(19) United States
(12) Patent Application Publication
(10) Pub. No.: US 2026/0149020 A1
(43) Pub. Date: May 28, 2026

(54) PHOTOVOLTAIC APPARATUS PREPARED FROM REGENERATIVE BIOMATERIAL

(71) Applicant: ECO RESEARCH SDN. BHD., Pulau Pinang (MY)

(72) Inventors: Chee Wei CHAN, Kallang (SG); Kah Aik TAN, Kallang (SG); Teck Soon SIM, Kallang (SG); Tian Lik TEH, Kallang (SG)

(21) Appl. No.: 19/122,532

(22) PCT Filed: Oct. 17, 2023
(86) PCT No.: PCT/SG2023/050699

§ 371 Date: Apr. 18, 2025

Related U.S. Application Data
(60) Provisional application No. 63/417,375, filed on Oct. 19, 2022.

(51) Int. Cl. H01M 8/16; H01G 9/022

(52) U.S. Cl. CPC H01M 8/16; H01G 9/022

(57) ABSTRACT

A photovoltaic apparatus prepared from a regenerative biomaterial, the apparatus comprising a carrier, one or more microalgae cells, a cathode, a permeable diaphragm, and an electrolyte. The carrier comprises a plurality of conductive sheets extending in a planar direction. The conductive sheets are electrically connected to each other. The microalgae cells are arranged on the carrier. The permeable diaphragm is arranged between the carrier and the cathode. The electrolyte is an algae culture medium and is in contact with the cathode and the microalgae cells. Each conductive sheet is provided with a first surface area for arranging the microalgae cells and in contact with the electrolyte. The cathode is provided with a second surface area in contact with the electrolyte. The microalgae cells capture sunlight in the electrolyte and grow a microalgae layer on the conductive sheets to serve as an anode.

### FIELD OF THE INVENTION

The present invention relates to a photovoltaic device, and more particularly to a photovoltaic device prepared using regenerable biomaterials.

### BACKGROUND OF THE INVENTION

Conventional photovoltaic devices (or solar cells) predominantly utilize semiconductor materials, with silicon being the most common. Other materials include GaAs, GaAlAs, InP, CdS, CdTe, and the like.

With the increasing demand for regenerable energy, the usage of semiconductor materials or compound materials required for conventional photovoltaic devices has also risen. However, issues such as energy consumption, environmental pollution, and high costs associated with the production and recycling processes of these materials have increasingly come under scrutiny and criticism. Particularly for photovoltaic devices with high power generation efficiency, the need for higher-purity materials exacerbates these problems, making them more significant.

Recently, bio-photovoltaic devices have been proposed to produce photovoltaic devices in a cleaner and more energy-efficient manner, as exemplified by patents such as U.S. Pat. No. 9,730,433B2, US 2012/0325290A1, and U.S. Pat. No. 8,373,064B2. However, existing bio-photovoltaic devices suffer from poor power generation efficiency, indicating a need for further improvement.

### SUMMARY OF THE INVENTION

The present invention provides a photovoltaic device prepared from regenerable biomaterials, comprising a carrier, one or more microalgae cells, a cathode, a permeable membrane, and an electrolyte. The carrier includes a plurality of conductive sheets extending along a planar direction, and the conductive sheets are electrically connected to each other. The microalgae cells are disposed on the carrier. The microalgae cells are selected from Spirulina sp., Anabaena sp., Oscillatoria sp., Chlorella sp., Chlorococcum sp., or combinations thereof. The cathode is a conductive material. The permeable membrane is disposed between the carrier and the cathode. The electrolyte is capable of serving as a culture medium for microalgae and is in contact with both the cathode and the microalgae cells. Each of the conductive sheets has a first surface area for supporting the microalgae cells and contacting the electrolyte, and the cathode has a second surface area contacting the electrolyte. The ratio of the total sum of the first surface areas of the conductive sheets to the second surface area of the cathode ranges from 32 to 64. The microalgae cells capture sunlight within the electrolyte and grow into a microalgae layer on the conductive sheets, functioning as an anode.

In one embodiment, the photovoltaic device further comprises a light-transmissive container and a reaction chamber defined by the light-transmissive container, wherein the anode, the cathode, and the electrolyte are disposed within the reaction chamber.

In one embodiment, the microalgae cells are green algae or blue algae.

In one embodiment, the permeable membrane is a Nafion polymer membrane, a glass fiber membrane, an organic porous membrane, an inorganic porous membrane, or a filter paper.

In one embodiment, the electrolyte is a Zarrouk medium or a Bold Basal medium.

In one embodiment, the ratio ranges from 44 to 52.

In one embodiment, the photovoltaic device generates a voltage peak greater than 450 m V.

In one embodiment, the photovoltaic devices are connected in series.

In one embodiment, the photovoltaic device assembly provides a current of at least 2 mA.

In one embodiment, the photovoltaic device assembly provides a voltage of at least 3 V.

### BRIEF DESCRIPTION OF THE DRAWINGS

Example embodiments of the present disclosure will be described with reference to the accompanying drawings briefly described below.

FIG. 1 is a schematic diagram of a photovoltaic device according to an embodiment of the present invention.

FIG. 2 is a schematic diagram of a photovoltaic device according to an experimental example of the present invention.

FIG. 3 is a photograph of a photovoltaic device according to an experimental example of the present invention.

FIG. 4 is a data graph of voltage and current for the experimental example of FIG. 3.

FIG. 5 is a photograph of the experimental example of FIG. 3 at week 2.

FIG. 6 is a photograph of a photovoltaic device assembly according to an experimental example of the present invention.

FIG. 7 is a data graph of voltage and current for the experimental example of FIG. 6.

FIG. 8 is a photograph of the experimental example of FIG. 6 illuminating an LED bulb.

FIG. 9 is a data graph of voltage and current for an experimental example of the present invention using different microalgae cells.

### DETAILED DESCRIPTION

Although terms such as “first,” “second,” and the like used herein and in the claims describe certain elements or features, these terms are not intended to limit the elements or features. These terms are merely used to distinguish one element or feature from another. For example, a first element or feature may be interpreted as a second element or feature, and similarly, a second element or feature may be interpreted as a first element or feature.

When an element is referred to as being “on,” “covering,” or “above” another element, it may be directly on, directly covering, or directly above that element, or intervening elements may be present. Conversely, when an element is referred to as being “directly on,” “directly covering,” or “directly above” another element, no intervening elements are present.

The terminology used in the description herein and in the claims is for the purpose of describing particular examples only and is not intended to be limiting. Unless the context clearly indicates otherwise or intentionally limits the number of elements, the singular forms “a”, “an”, and “the” as used herein also include the plural forms. It is further understood that the terms “comprises”, “comprising”, “includes” and/or “including,” when used herein, specify the presence of stated features, elements, and/or components, but do not preclude the presence or addition of one or more other features, elements, components, and/or groups thereof. Indefinite and definite articles include both plural and singular forms unless the context clearly indicates otherwise.

Unless otherwise specified, all numerical values of dimensions, quantities, and physical properties used herein and in the claims are to be understood as being modified in all instances by the term “about.” Accordingly, unless indicated to the contrary, the numerical parameters set forth herein and in the claims are approximations that may vary depending on the desired properties sought to be obtained by those skilled in the art utilizing the teachings disclosed herein and in the claims. The use of numerical ranges expressed by endpoints includes all numbers within that range and any range within that range, e.g., 1 to 5 includes 1, 1.2, 1.5, 1.7, 2, 2.75, 3, 3.80, 4, and 5, and so forth.

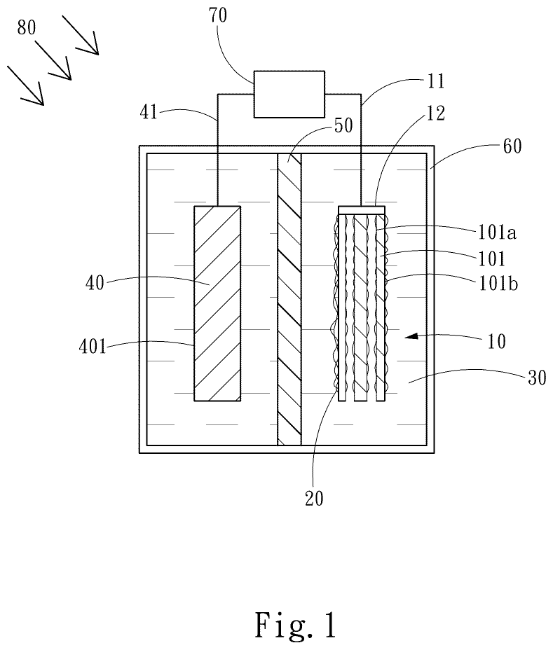

The present invention discloses a photovoltaic device prepared using regenerable biomaterials. Referring to FIG. 1, in one example, the photovoltaic device comprises a carrier 10, one or more microalgae cells 20, an electrolyte 30, a cathode 40, and a permeable membrane 50. The electrolyte 30 is placed within a reaction chamber of a container 60.

The carrier 10 comprises a plurality of conductive sheets 101 extending along a planar direction, wherein the conductive sheets 101 are electrically connected to each other. In this embodiment, the conductive sheets 101 are electrically connected via a conductive connector 12. The conductive sheets 101 are configured to support the one or more microalgae cells 20. Each conductive sheet 101 has a first surface 101a and a second surface 101b opposite the first surface 101a. The one or more microalgae cells 20 are disposed on the first surface 101a and the second surface 101b of the conductive sheets 101. The carrier 10 is placed in the electrolyte 30. The conductive sheets 101 may be made of a metal such as aluminum, stainless steel, copper, or other conductive non-metallic materials.

The one or more microalgae cells 20 are immersed in the electrolyte 30. The one or more microalgae cells 20 may be selected from Spirulina sp., Anabaena sp., Oscillatoria sp., Chlorella sp., Chlorococcum sp., or combinations thereof. In one example, the microalgae cells 20 consist of a single species, while in some examples, the microalgae cells 20 may comprise two or more species. In one example, the microalgae cells 20 are green algae or blue algae.

The electrolyte 30 serves as a medium, such as a Zarrouk medium or a Bold Basal medium, for algae cultivation and is permeable to light. The one or more microalgae cells 20 immersed in the electrolyte 30 grow on the carrier 10 to form a microalgae layer. The microalgae layer grown on the conductive sheets 101 functions as an anode.

The cathode 40 is placed in the electrolyte 30 and may comprise a carbon-based conductive paper or other cathode materials suitable for electrochemical cells.

The permeable membrane 50 is placed in the electrolyte 30 and disposed between the anode and the cathode 40. The permeable membrane 50 allows the movement of ions such as hydrogen ions (H) and hydroxide ions (OH), and may be a proton exchange membrane, such as a Nafion polymer membrane, a glass fiber membrane, an organic porous membrane, an inorganic porous membrane, or a filter paper.

The conductive sheets 101 are configured as flat sheets, with a thickness that is negligible compared to their length and width. Each conductive sheet 101 has a first surface area (the surface area of the first surface 101a plus the surface area of the second surface 101b). The cathode 40 may also be configured as flat sheet and has a second surface area 401. The first surface area and the second surface area 401 are defined as the areas in contact with the electrolyte 30. The ratio of the total sum of the first surface areas of the conductive sheets 101 (i.e., the number of conductive sheets 101 multiplied by the surface area of each conductive sheet 101) to the second surface area 401 of the cathode 40 ranges from 32 to 64. In one example, the ratio ranges from 44 to 52. By appropriately selecting the ratio between the first surface area and the second surface area 401, the power generation efficiency of the photovoltaic device can be optimized with minimal use of anode and cathode materials.

The conductive sheets 101 and the cathode 40 are electrically connected to a load 70 via an anode connector 11 and a cathode connector 41, respectively. The microalgae layer is a photosynthetic organism, and under light illumination 80, the one or more microalgae cells 20 immersed in the electrolyte 30 grow on the conductive sheets 101 to form the microalgae layer. The microalgae layer performs photosynthesis and drives water photolysis, in which the surrounding electrolyte dissociates to release oxygen, protons, and electrons. This process, along with the electrolyte 30 and the cathode 40, forms an electrochemical cell that supplies power to the load 70. The dissociated electrons move from the anode to the cathode 40, while oxygen and protons are reduced to water at the cathode 40. The microalgae layer may comprise filamentous cyanobacteria. The use of the plurality of conductive sheets 101, combined with the filamentous structure of the microalgae layer, significantly increases the surface area of the microalgae layer.

The following experimental examples further illustrate the present invention in detail. However, these experimental examples are not intended to limit the invention, and appropriate variations are permissible.

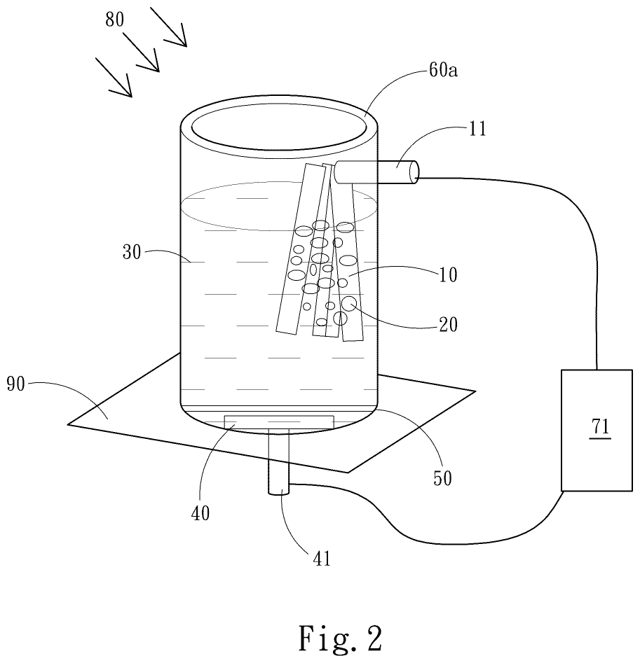

FIG. 2 illustrates the configuration of a photovoltaic device used in an experimental example. The container 60 is a tubular container 60a made of acrylic, with an inner diameter of approximately 36 mm and a height of approximately 100 mm. The tubular container 60a is filled with approximately 40 ml of the electrolyte 30 and placed on a support plate 90.

The carrier 10 includes six aluminum foil sheets, each with a single-sided surface area of approximately 8 cm². The microalgae cells 20 are Spirulina sp., placed on both sides of the aluminum foil sheet. The cathode 40 is carbon paper with a surface area of approximately 2 cm², positioned at a bottom of the tubular container 60a, with only a top surface exposed to the electrolyte 30. Thus, the total first surface area of the carrier 10 is approximately 96 cm², and the second surface area 401 of the cathode 40 is approximately 2 cm².

In this experimental example, a 10W (watts) LED is used to provide the light illumination 80, with a 12-hour light-dark cycle. The anode connector 11 and the cathode connector 41 are connected to a multimeter 71. In one example, the photovoltaic device generates a voltage peak greater than 450 m V.

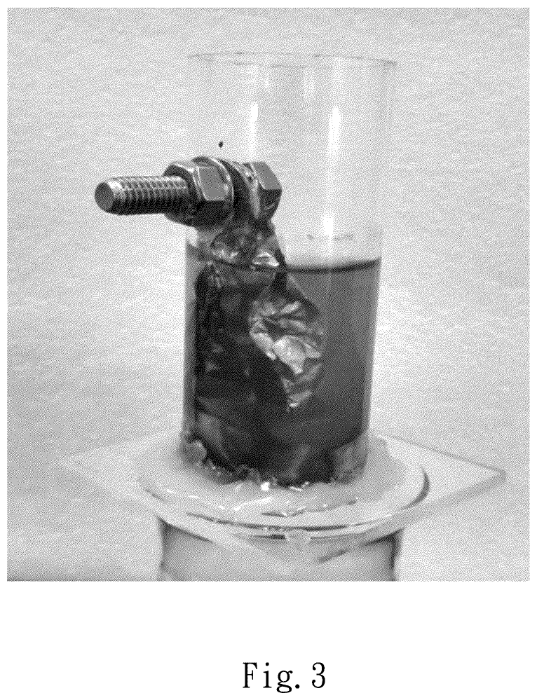

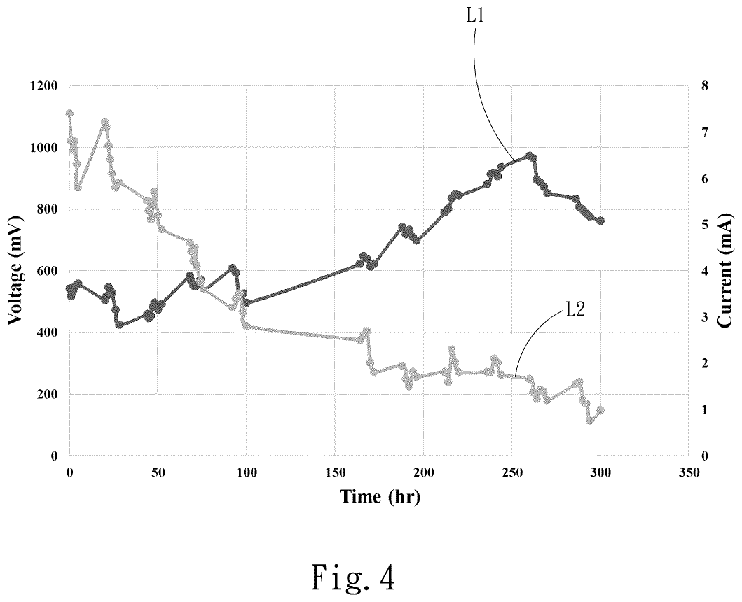

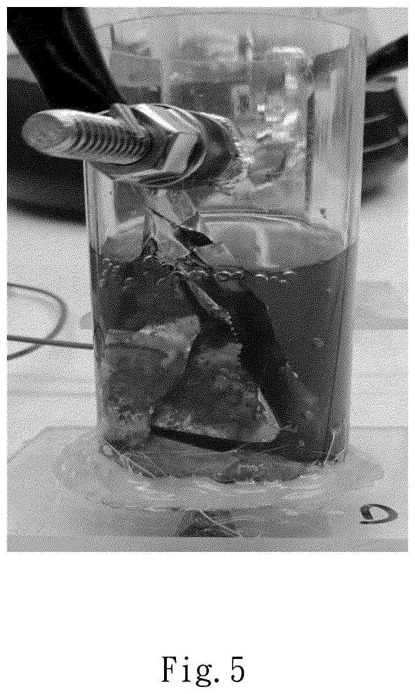

FIG. 3 shows a photograph of the photovoltaic device used in the experimental example. The operation and measurement period of the photovoltaic device was over approximately 2 weeks. The voltage and current of the photovoltaic device over these 2 weeks are shown in FIG. 4, with line L1 representing measured voltage and line L2 representing measured current. During the first week, the voltage ranges between 400 mV and 600 mV, while in the second week, the voltage exceeds 600 m V, reaching a peak of approximately 972 mV over the 2-week period. The measured current ranges between 1.0 mA and 8.0 mA. By observing the microalgae layer on the carrier 10, it was found that a newly formed microalgae layer grew on the carrier 10 in the second week, as shown in FIG. 5. The newly formed microalgae layer enhances water photolysis, thereby providing a higher voltage output.

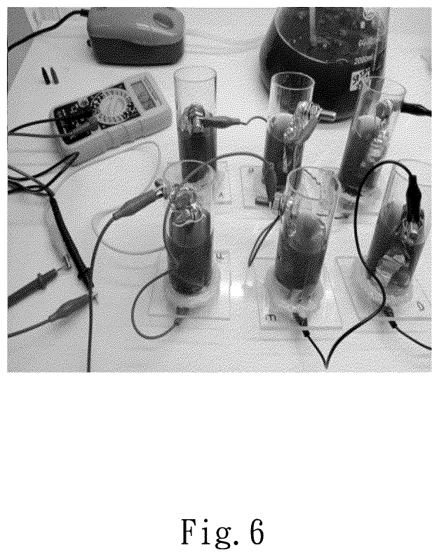

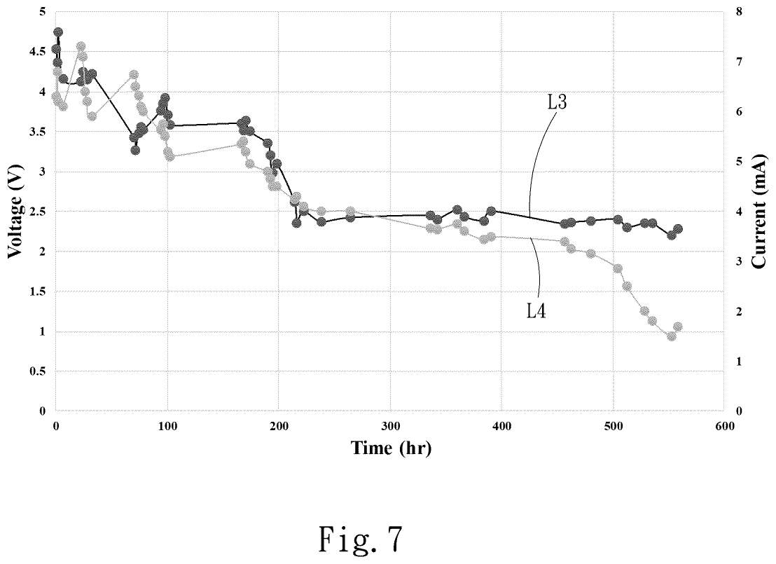

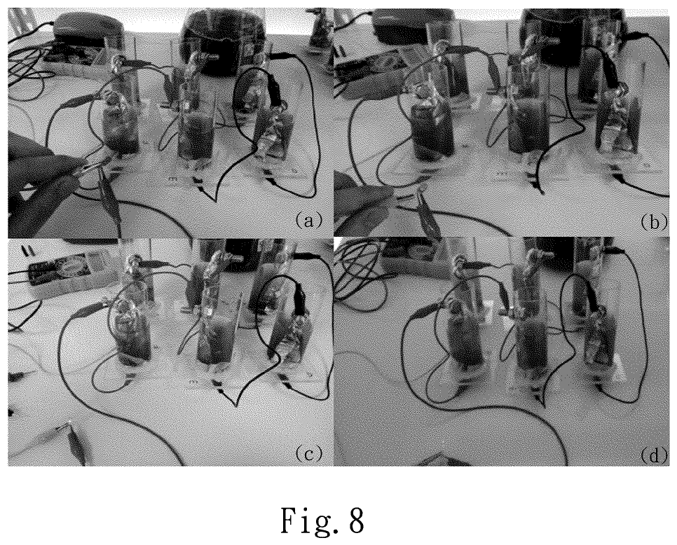

To test the commercial applicability of the photovoltaic device, the experimental example further connects six photovoltaic devices in series to form a photovoltaic device assembly, as shown in FIG. 6. The photovoltaic device assembly was operated and measured for approximately 3.5 weeks, achieving a voltage peak of 4.74 V and a current ranging from 2.0 mA to 7.0 mA, with voltage ranging from 3 V to 4.74 V. The voltage and current over these 3.5 weeks are shown in FIG. 7, with line L3 representing measured voltage and line L4 representing measured current. FIG. 8 further demonstrates that the photovoltaic device assembly is capable of powering LED bulbs, with parts (a) to (d) of FIG. 8 showing the illumination of red, green, white, and pink LED bulbs, respectively.

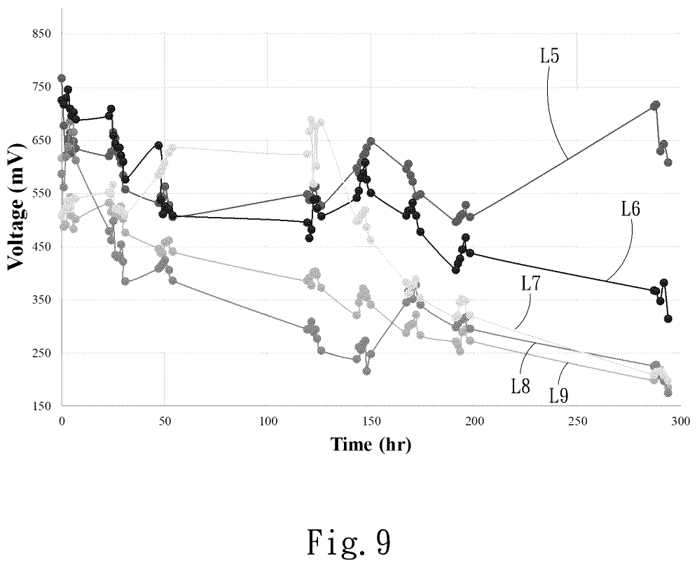

Table 1 presents the voltage ranges measured for the photovoltaic devices using various microalgae cells, configured as shown in FIG. 1. The voltage and current are shown in FIG. 9, with line L5 representing measured voltage of the photovoltaic device using Spirulina sp., line L6 representing measured voltage of the photovoltaic device using Oscillatoria sp., line L7 representing measured voltage of the photovoltaic device using Chlorococcum sp., line L8 representing measured voltage of the photovoltaic device using Anabaena sp., and line L9 representing measured voltage of the photovoltaic device using Chlorella sp. Due to differences in the experimental conditions of FIG. 9 compared to FIG. 4, the data differ even when using the same configuration (i.e., line L5 in FIG. 9 vs. line L1 in FIG. 4).

TABLE 1

| Group | Microalgae Cells | Voltage (mV) |
|---|---|---|
| Experimental Example 1 | Spirulina sp. | 525 to 765 |
| Experimental Example 2 | Anabaena sp. | 175 to 650 |
| Experimental Example 3 | Oscillatoria sp. | 315 to 725 |
| Experimental Example 4 | Chlorella sp. | 175 to 620 |
| Experimental Example 5 | Chlorococcum sp. | 200 to 700 |

To verify that the photovoltaic device of the present invention achieves superior power generation performance, Table 2 compares the peak voltages measured from an experimental example configured as shown in FIG. 1 with those measured from an experimental example prepared according to the following literature: Ahiahonu, E. K., Anku, W. W., Roopnarain, A., Green, E., Serepa-Dlamini, M. H., & Govender, P. P. (2022). Exploring indigenous freshwater chlorophytes in integrated biophotovoltaic system for simultaneous wastewater treatment, heavy metal biosorption, CO₂ biofixation and biodiesel generation. Bioelectrochemistry, 147, 108208.

TABLE 2

| | Microalgae | | | Peak Voltage |
|---|---|---|---|---|
| Group | Cells | Anode | Cathode | (mV) |
| Experimental | Spirulina sp. | Multiple | Carbon | Approx. 972 |
| Example | | Aluminum | Paper | |
| | | Sheets | | |
| Comparative | Tetradesmus | Single | Single | Approx. 326.80 |
| Example | sp. | Copper | Copper | |
| | | Sheet | Sheet | |

According to the present invention, by utilizing the filamentous cyanobacteria of the microalgae layer in conjunction with the configuration of multiple conductive sheets 101, the surface area of the microalgae layer can be significantly increased. Additionally, by controlling the ratio between the first surface area and the second surface area, the photovoltaic device is able to achieve excellent power generation performance using low-cost materials and configurations.

1. A photovoltaic device prepared from regenerable biomaterials, comprising:
a carrier comprising a plurality of conductive sheets extending along a planar direction, the plurality of conductive sheets being electrically connected to each other;
one or more microalgae cells disposed on the carrier, wherein the microalgae cells are selected from Spirulina sp., Anabaena sp., Oscillatoria sp., Chlorella sp., Chlorococcum sp., or combinations thereof;
a cathode being a conductive material;
a permeable membrane disposed between the carrier and the cathode; and
an electrolyte capable of serving as a culture medium for microalgae and permeable to light, the electrolyte being in contact with the cathode and the microalgae cells;
wherein each of the plurality of conductive sheets has a first surface area for supporting the microalgae cells and contacting the electrolyte, the cathode has a second surface area contacting the electrolyte, and a ratio of a total sum of the first surface areas of the plurality of conductive sheets to the second surface area of the cathode ranges from 32 to 64; and
wherein the microalgae cells in the electrolyte capture light and grow into a microalgae layer on the plurality of conductive sheets, functioning as an anode.

2. The photovoltaic device according to claim 1, wherein further comprises a light-transmissive container and a reaction chamber defined by the light-transmissive container, and wherein the anode, the cathode, and the electrolyte are disposed within the reaction chamber.

3. The photovoltaic device according to claim 1, wherein the microalgae cells are green algae or blue algae.

4. The photovoltaic device according to claim 1, wherein the permeable membrane is a Nafion polymer membrane, a glass fiber membrane, an organic porous membrane, an inorganic porous membrane, or a filter paper.

5. The photovoltaic device according to claim 1, wherein the electrolyte is a Zarrouk medium or a Bold Basal medium.

6. The photovoltaic device according to claim 1, wherein the ratio ranges from 44 to 52.

7. The photovoltaic device according to claim 1, wherein the photovoltaic device generates a voltage peak greater than 450 mV.

8. A photovoltaic device assembly comprising a plurality of photovoltaic devices according to claim 1, wherein the photovoltaic devices are connected in series.

9. The photovoltaic device assembly according to claim 8, wherein the photovoltaic device assembly provides a current of at least 2 mA.

10. The photovoltaic device assembly according to claim 8, wherein the photovoltaic device assembly provides a voltage of at least 3V.
